(19) United States
(12) Patent Application Publication
(10) Pub. No.: US 2022/0234496 A1
(43) Pub. Date: Jul. 28, 2022

(54) DEVICE FOR SIGNALING A VEHICLE ENCUMBRANCE

(71) Applicant: S.M.A.T. NORD S.R.L., Torino (IT)

(72) Inventor: Gianfranco AMBROSI, Torino (IT)

(21) Appl. No.: 17/614,834

(22) PCT Filed: May 26, 2020
(86) PCT No.: PCT/IB2020/054969

§ 371 Date: Nov. 29, 2021

(30) Foreign Application Priority Data
May 29, 2019 (IT) 102019000007512

(51) Int. Cl. B60Q 1/26

(52) U.S. Cl. CPC B60Q 1/2657; B60Q 2800/00

(57) ABSTRACT

A device for signaling a vehicle encumbrance, in particular a transverse encumbrance of said vehicle, in particular usable on agricultural and/or forestry machinery or for signaling a load protruding from said vehicle, comprising means for signaling the overall dimensions and means which connect said signaling means to the same vehicle. Said means which connect said signaling means to the same vehicle are adapted to support said signaling means in respective positions, in particular transversal with respect to the same vehicle, said positions being comprised between a maximum extension position and a minimum extension position with respect to said vehicle.

### FIELD OF APPLICATION OF THE PRESENT INVENTION

The present invention refers to a device for signaling a vehicle encumbrance.

In particular, the present device is especially suitable for signaling a transverse encumbrance of said vehicle, and is especially usable on agricultural and/or forestry machinery or for signaling a load protruding from said vehicle.

### STATE OF THE ART

Devices are known for signaling an encumbrance, in particular a load protruding from a vehicle, in particular protruding laterally from the same vehicle, which comprise means for signaling the overall dimensions and means which connect said signaling means to the same vehicle.

These already-known signaling devices are rigidly fixed to the vehicle through corresponding connection means.

In practice, through these already-known signaling devices, for each vehicle or load it is necessary to arrange a corresponding connecting support for supporting said signaling means or panel at the vehicle and all this involves the need to make a plurality of connecting supports, each suitable for a specific size of the load to be signaled—all of the above involves considerable losses of time for the employed personnel.

Furthermore, it can also occur that a corresponding signaling panel will be erroneously mounted on the respective support, i.e. with corresponding retro-reflective strips which are arranged with an oblique orientation that is not legally compliant with the law, with the need to remake said assembly, or even worse, the vehicle would travel in a manner that is not compliant with current laws.

### SUMMARY OF THE INVENTION

With the present invention, it is desired to propose a new solution, alternative to the solutions known up to now and in particular it is proposed to overcome one or more of the drawbacks or problems referred to above and/or to satisfy one or more of the needs mentioned above and/or in any case indicated in the art and in particular inferable from that stated above.

A device is then provided for signaling a vehicle encumbrance, in particular of a transverse encumbrance of said vehicle, in particular usable on agricultural and/or forestry machinery or for signaling a load protruding from said vehicle, comprising means for signaling the overall dimensions and means which connect said signaling means to the same vehicle; characterized in that said means which connect said signaling means to the same vehicle are adapted to support said signaling means in respective positions, in particular transversal with respect to the same vehicle, said positions being comprised between a maximum extension position and a minimum extension position with respect to said vehicle.

In this manner, it is possible to use the same device for different use situations, in particular for different sizes of the vehicle, in particular of the agricultural and/or forestry vehicle, i.e. for different types of protruding loads.

### BRIEF DESCRIPTION OF THE DRAWINGS

This and other innovative aspects, or specific advantageous embodiments, are in any case described in the below-reported claims, whose technical characteristics can be found in the following detailed description, illustrating preferred and advantageous embodiments, which are nevertheless to be considered as merely exemplifying and non-limiting of the invention; said description being made with reference to the enclosed drawings, in which:

FIG. 1 illustrates a perspective schematic view of a preferred embodiment of a device according to the present invention;

FIG. 2 illustrates a front elevation schematic view of the preferred embodiment of a device according to the present invention;

FIG. 3 illustrates a top plan schematic view of the preferred embodiment of a device according to the present invention;

FIG. 4 illustrates a side elevation schematic view of the preferred embodiment of a device according to the present invention;

FIG. 5 illustrates an exploded perspective schematic view of the preferred embodiment of a device according to the present invention;

FIG. 6A illustrates a front elevation schematic view, partially disassembled, of the preferred embodiment of a device according to the present invention;

FIG. 6B illustrates a perspective schematic view, partially disassembled, of the preferred embodiment of a device according to the present invention;

FIG. 7A illustrates a front elevation schematic view, partially disassembled, of the preferred embodiment of a device according to the present invention, with, mounted thereon, the element for supporting the emission means of a corresponding light radiation;

FIG. 7B illustrates a perspective schematic view, partially disassembled, of the preferred embodiment of a device according to the present invention, with, mounted thereon, the element for supporting the emission means of a corresponding light radiation;

FIG. 8 illustrates a front elevation schematic view, illustrating only a part of the block for supporting the signaling means, of the preferred embodiment of a device according to the present invention;

FIG. 9 illustrates a front elevation schematic view, illustrating the end work positions of the arm for supporting the signaling means of the preferred embodiment of a device according to the present invention;

FIG. 10A illustrates an enlarged longitudinal section schematic view of a part of the preferred embodiment of a device according to the present invention;

FIG. 10B illustrates an enlarged cross section schematic view, taken according to line C-C of FIG. 10A, of part of the preferred embodiment of a device according to the present invention;

FIG. 10C illustrates an enlarged cross section schematic view, taken according to line B-B of FIG. 10A, of part of the preferred embodiment of a device according to the present invention;

FIG. 10D illustrates a perspective schematic view of the preferred embodiment of connecting means to the vehicle of the device according to the present invention, in open condition;

FIG. 10E illustrates an exploded perspective schematic view of an enlarged detail of the preferred embodiment of a device according to the present invention;

FIG. 10F illustrates a schematic view of the enlarged detail of the perspective view of FIG. 10E, in assembled condition;

FIG. 10G illustrates an exploded perspective schematic view of an enlarged detail of the preferred embodiment of a device according to the present invention, taken from the side opposite that of FIG. 10E;

FIG. 10H illustrates a schematic view of the enlarged detail of the perspective view of FIG. 10G, in assembled and overturned condition;

FIG. 10I illustrates a perspective cross section schematic view of an enlarged detail of the preferred embodiment of a device according to the present invention.

### DETAILED DESCRIPTION OF PREFERRED EMBODIMENTS OF THE INVENTION

In the enclosed figures, a preferred embodiment 1 is illustrated of a device for signaling a vehicle encumbrance, in particular of a transverse encumbrance of said vehicle, in particular usable on agricultural and/or forestry machinery or for signaling a load protruding from said vehicle.

As illustrated, the device 1 comprises respective means 11 for signaling the overall dimensions and the corresponding means 10, which connect said signaling means 11 to the same vehicle.

Advantageously, as illustrated, it is provided that said means 10 which connect said signaling means 11 to the same vehicle are adapted to support said signaling means 11 in respective positions, in particular transversal with respect to the same vehicle, said positions being comprised between a maximum extension position and a minimum extension position with respect to said vehicle.

In this manner, it is possible to use the same device 1 for different use situations, in particular for different vehicle sizes, in particular of the agricultural and/or forestry vehicle, i.e. for different types of protruding loads.

Advantageously, as is inferred from the figures, said means which connect said signaling means 11 to the same vehicle comprise, or they are in the form of, an extensible support 10, in particular, in use, extensible transversely to the vehicle, and such support is especially suitable for arranging said signaling means 11 between said maximum extension position and said minimum extension position with respect to the same vehicle.

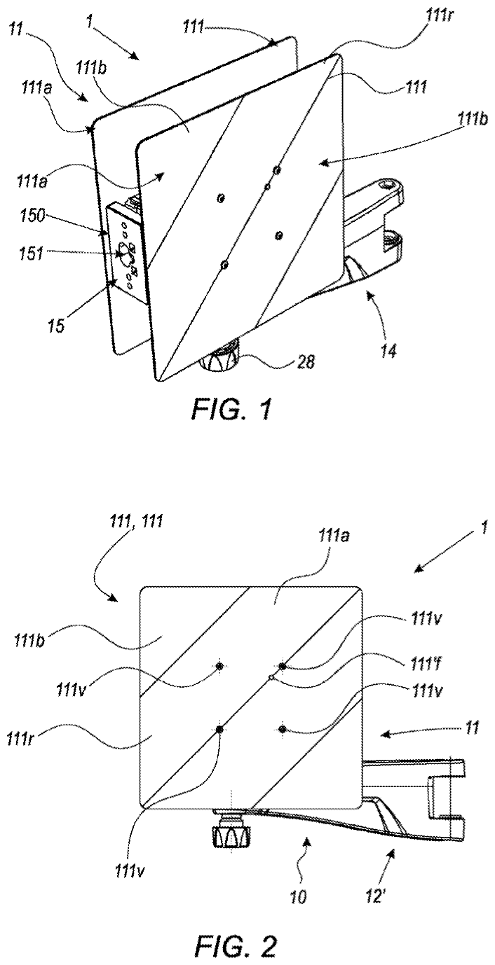

In an advantageous manner, as is inferred in particular from FIGS. 1 to 5, said signaling means 11 comprise at least one corresponding signaling panel 111, especially having a respective retro-reflective face 111a and/or a signaling strips, and in particular facing, in use, transversely with respect to a corresponding longitudinal direction of the vehicle.

Preferably, in any case, as is inferred from said FIGS. 1 to 5, said signaling means 11 comprise a first and a second panel 111, 111, especially retro-reflective and/or a signaling strips, which face in opposite directions, in particular face transversely with respect to opposed longitudinal directions of the vehicle.

Conventionally, the longitudinal axis of the vehicle can be defined as the axis coinciding with the main extension dimension of the same vehicle.

In practice, a first panel 111, especially having a respective retro-reflective face 111a and/or a signaling strips, faces towards the rear part of the vehicle, while a second panel 111, especially having a respective retro-reflective face 111a and/or a signaling strips, faces towards the front part of the vehicle.

As a particular advantage, as illustrated, said first and second panels, 111, 111, especially retro-reflective and/or a signaling strips, are arranged parallel and/or longitudinally aligned with each other.

As a particular advantage, as illustrated, said first and second panels, 111, 111, especially retro-reflective and/or a signaling strips, have square shape and/or, in any case, have the same dimensions.

With advantage, as is inferred in particular from said FIGS. 1 to 5, the respective signaling panel 111 is in the form of a thin metal or plastic plate, in particular having a respective retro-reflective surface 111a, especially in strips, preferably oblique, and preferably in alternate strips of white and red color 111b, 111r. In practice, the orientation of the oblique strips must, according to corresponding laws, have—starting from the edge of the panel which faces towards the vehicle—a progression which is descending, i.e. which goes from top to bottom, in the direction of the edge of the panel which is outside the vehicle or transported load.

With particular advantage, said signaling means comprise means for emitting a light radiation, not particular, illustrated in the enclosed figures, and in particular means for emitting a red color light radiation, and normally in the form of at least one lamp, possibly also an LED lamp.

In use on the device 1, preferably, said emission means of a light radiation, in use, protrude, in particular laterally, with respect to the corresponding signaling panel 111, i.e. with respect to said first and second signaling panels 111, 111, preferably on the side of the respective panel 111 which is opposite that which faces towards the vehicle.

In practice, said emission means of a light radiation, in use, are arranged between said first and second panels 111, 111 and protrude, in particular laterally, with respect to said first and second signaling panels 111, 111, preferably on the side of the respective panel 111 which is opposite that which faces towards the vehicle.

In an advantageous manner, as is inferred from the figures, means 13 are provided for supporting said signaling means 11, or the respective signaling panel 111 and/or said emission means of a light radiation, on said means or support 10 for connecting to the vehicle.

Advantageously, as is inferred from the figures, said means 13 for supporting said signaling means 11 on said means or support 10 for connecting to the vehicle comprise a respective support block 13, preferably suitably made of a corresponding plastic material.

With advantage, as is inferred from the figures, said support means or block 13 have a configuration, in particular general prismatic configuration, which is adapted to define, for the respective signaling panel 111, a corresponding engagement surface 130s preferably, as illustrated, for engaging the central zone of the corresponding panel 111.

In particular, said support means or block 13 having opposed first and second engagement surfaces 130s, 130s for said first and second signaling panels 111, 111.

Preferably, as is inferred from the figures, said block 13, at the respective engagement surface 130s, 130s has an extension of the respective side which is greater than at least the fourth part of the length of the corresponding side of said signaling panel 111.

In this manner, it is possible to obtain a firm and strong support of the corresponding signaling panel 111.

In an advantageous manner, as is inferred from the figures, said support means or block 13 have corresponding attachment means 130f for the respective signaling panel 111, preferably provided at the respective engagement face or surface 130s.

In particular, first and second attachment means 130f, 130f are provided or emerge at opposite engagement faces or surfaces 130s, 130s of said support means or block 13 for the opposed fixing of said first and second signaling panel 111, 111.

Advantageously, as is inferred from the figures, said attachment means for the corresponding signaling panel 111 on the support means or block 13 comprise corresponding holes 130f, provided on the corresponding engagement face or surface 130s, 130s, for inserting corresponding fixing screws 130v for fixing the respective signaling panel 111.

In particular, first and second holes 130f, 130f are provided on engagement faces or surfaces 130s, 130s opposite said support means or block 13 for the opposed fixing of said first and second signaling panels 111, 111.

As illustrated, said screws 130v have a respective enlarged head and are inserted in corresponding holes 111f provided in the respective signaling panel 111, traversing them in order to be inserted in said holes 130f at the respective engagement face or surface of said support means or block 130.

With particular advantage, as is inferred from the figures, means 111′f are provided which are adapted to allow the assembly with correct orientation of the corresponding signaling panel 111.

In this manner, it is possible to prevent the assembly of the respective signaling panel from taking place in an incorrect manner, with the need to have to remake said assembly, or even worse a vehicle would result that travels in a manner non-compliant with the law.

In an advantageous manner, as is inferred from the figures, said means which are adapted to allow the assembly with correct orientation of the corresponding signaling panel 111 comprise a corresponding insertion hole 111′f for a corresponding screw or pin, only when the respective panel is in the correct mounting position.

With advantage, as is inferred from the figures, the respective signaling panel 111 comprises four insertion holes 111f for corresponding attachment screws 111v, and such four holes 111f are arranged at the vertices of a corresponding virtual square. Advantageously, a fifth hole 111′f is also provided in said signaling panel 111 for the insertion of a corresponding screw or pin, defining said mounting means with correct orientation of the corresponding signaling panel 111; said fifth hole 111′f being provided, on the virtual diagonal between two holes 111v at the vertices of said virtual square. In particular, advantageously, as illustrated, said fifth hole 111′f provided on the diagonal is in greater proximity to one of said opposite holes, between which the same virtual diagonal extends.

In this manner, an incorrect assembly of the respective signaling panel is prevented in a simple and inexpensive manner; such incorrect assembly would require remaking the assembly, or worse, would involve having a car that travels in a manner that is not legally compliant.

Advantageously, as is inferred from the figures, an element 15 is provided which is adapted to support said emission means of a light radiation.

In this manner, it is possible to arrange, on the device, also means which are adapted to emit a corresponding light radiation.

In an advantageous manner, as is inferred from the figures, said element 15 which is adapted to support said emission means of a light radiation is engageable with and disengageable from said means or block 13 for fixing said signaling means 11.

In this manner, it is possible to use elements for supporting different means which are adapted to emit a corresponding light radiation.

Advantageously, as is inferred from the figures, the respective element 15 for supporting said emission means of a light radiation comprises means for engaging and disengaging the corresponding emission means of a light radiation, in particular in the form of a corresponding seat 151, in which the emission means of a light radiation are engageable and disengageable.

In this manner, it is possible to substitute the same emission means of the light radiation, if necessary.

With advantage, as is inferred from the figures, said element 15 for supporting said emission means of a light radiation is in the form of a corresponding block 150, in particular made of rigid material, preferably of plastic material, especially with general prismatic shape, and preferably having an enlarged plate 154, defining a corresponding front surface that emerges or is positioned outside the seat 151 for engaging and disengaging emission means of a light radiation, and a corresponding attachment portion 155, in particular with prismatic shape, and preferably hollow, which is extended from said enlarged plate 154, and which is delimited by corresponding peripheral faces, one or more of which, in particular that opposite the insertion face of said screws 153v, 153v, as will be better inferred from the following present description, engages with a corresponding surface 135 of said means or block 13 for supporting said signaling means 11.

In an advantageous manner, as is inferred from the figures, said element or block 15 for supporting said emission means of a light radiation has respective through holes 152f, 152f, in particular in the form of a first and a second hole 152f, 152f, preferably being opened at opposite lateral surfaces of the same support element or block 15, or of the corresponding attachment portion 155, and in which corresponding screws 153v, 153v are inserted for attaching to said means or block 13 for supporting said signaling means 11, in particular in the form of a first and a second screw 153v, 153v, which, furthermore, are inserted in corresponding holes 135f, in particular in the form of a first and a second hole 135f, 135f, provided in the same means or block 13 for supporting said signaling means 11.

With particular advantage, as is inferred from the figures, said means or support 10 for connecting said signaling means 11 to said vehicle comprise means 12 for connecting to said vehicle and means 14 for supporting said signaling means 11.

Advantageously, as is inferred from the figures, said means 14 for supporting said signaling means 11 are extendable, or movable, with respect to said means 12 for connecting to said vehicle, so as to arrange said signaling means 11 between said maximum extension position and said minimum extension position with respect to the same vehicle.

In an advantageous manner, as is inferred from the figures, said means 14 for supporting said signaling means 11 comprise a corresponding arm 141, which carries said signaling means 11, and such arm 141 is slidable or movable with respect to said means 12 for connecting to said vehicle.

With advantage, as is inferred from the figures, said arm, which carries said signaling means 11, is in the form of an elongated element, preferably in the form of an elongated tubular element, 141, having a respective free end 142 for supporting said signaling means 11.

Advantageously, as is inferred from the figures, said arm 141, which carries said signaling means 11, preferably made of respective tubular metal material, has a main longitudinal branch, preferably horizontal in use, 141′, and in particular lower in use, for coupling with said means 12 for connecting to the vehicle.

In an advantageous manner, as is inferred from the figures, said arm 141 which carries said signaling means 11, or the respective free end 142, has respective means for coupling with said means or block 13 for fixing said signaling means 11.

With particular advantage, as is inferred from the figures, said means 142, for coupling with said means or block 13 for fixing said signaling means 11, comprise a corresponding portion or branch 142a of said support arm 141, which is protruding perpendicularly, in particular in use protruding upward, in particular from said main longitudinal branch or portion 141′ of the same arm 141, to which it is preferably connected through a corresponding curved connector portion 142ab.

In this manner, it is possible to arrange said signaling means in an appropriate height position with respect to the load and to the vehicle.

With advantage, as is inferred from the figures, said means for coupling with said means or block 13 for fixing said signaling means 11 comprise a portion or branch 142b of said support arm, which has returned backward, in particular extending from said perpendicularly protruding portion or branch 142a and which is in particular parallel to the main longitudinal branch 141′ of the same support arm 141, to which it is preferably connected through a corresponding curved connector portion 142ab.

In this manner, one end is obtained of said support arm 141 which allows exerting an effective attachment action for said means or block 13 for supporting said signaling means 11.

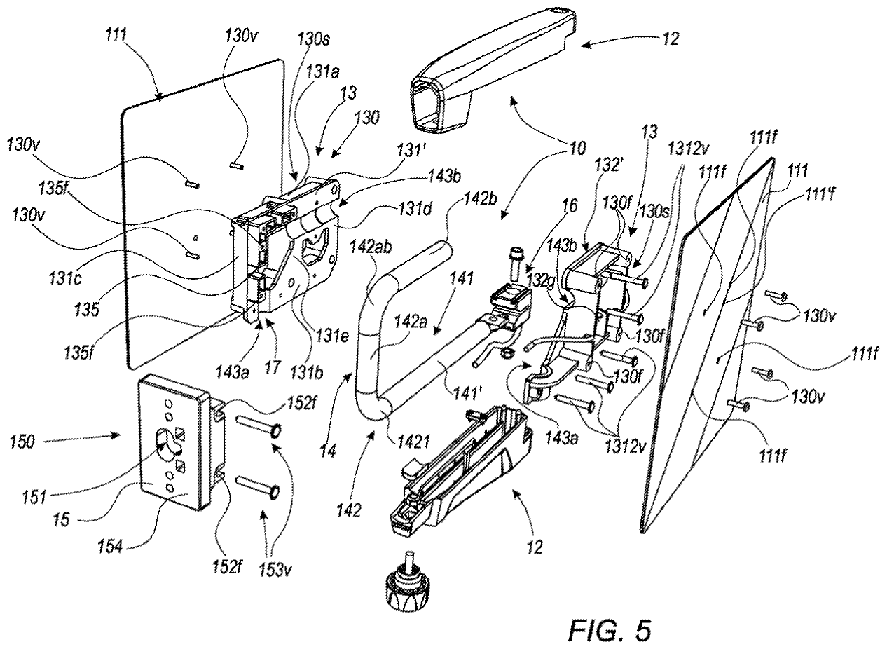

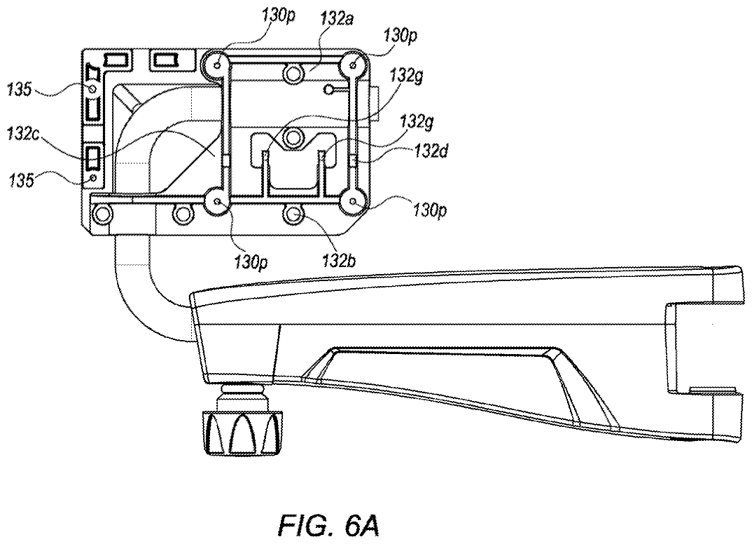

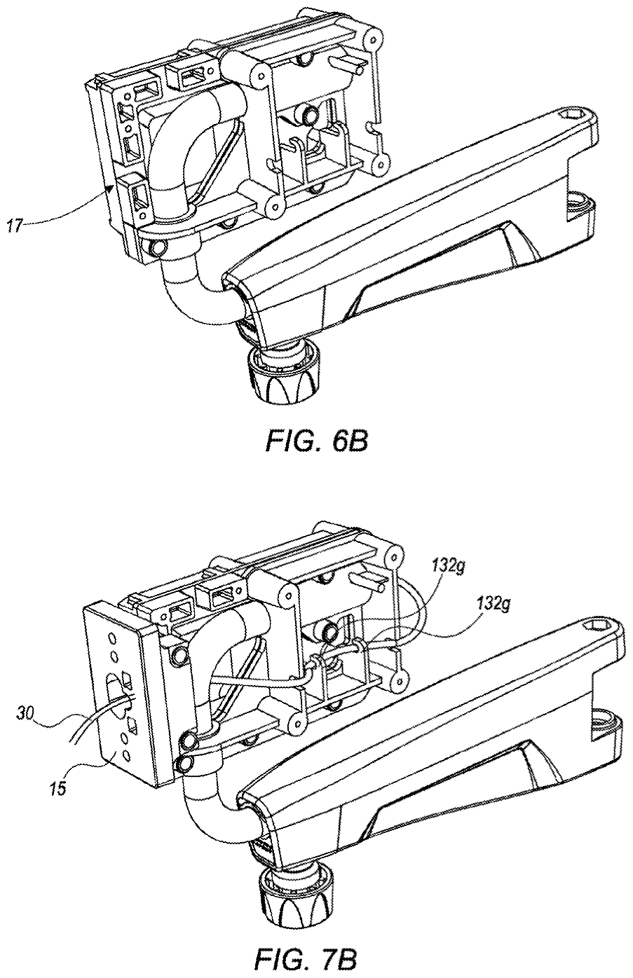

In an advantageous manner, as is inferred in particular from FIG. 5, said means or block 13 for supporting said signaling means 11 comprise a first and a second distinct part 131, 132 which are counterfacing and joined together, in particular each being made of corresponding plastic material.

Advantageously, as is inferred in particular from FIG. 5, said means or block 13 for supporting said signaling means 11 comprise a first and a second distinct part 131, 132 which are counterfacing and joined together, so as to define, between the same corresponding means, a receiving seat for said coupling means 142 of said support arm 141, in particular for receiving said portion or branch 142a of said support arm 141, which is protruding perpendicularly and/or of said portion or branch 142b of said support arm, which has returned backward.

In this manner, a quick and effective coupling is obtained between said means or block 13 for supporting said signaling means and said support arm 141.

Advantageously, as is inferred in particular from FIGS. 5, 7A and 8, said first part 131 said means or block 13 for supporting said signaling means 11 is in the form of a respective generally hollow body, in particular a general elongated quadrangular shape, which comprises a first and a second longitudinal element 131a, 131b connected to each other through corresponding first and second perpendicular end elements 131c, 131d and an intermediate perpendicular element 131e.

Meanwhile, in turn, said second part 132 of said means or block 13 for supporting said signaling means 11 is in the form of a body, also generally hollow, in particular with general quadrangular shape and comprises a first and a second longitudinal element 132a, 132b, with one 132b, that lower in use, extending longitudinally beyond the other 132a, in use counterfacing said longitudinal elements 131a, 131b of the first part 131, and connected to each other through corresponding first and second perpendicular end elements 132c, 132d, in use, respectively counterfacing the intermediate perpendicular element 131e and the corresponding perpendicular end element 131d of said first part 131 of said means or block 13 for supporting said signaling means 11.

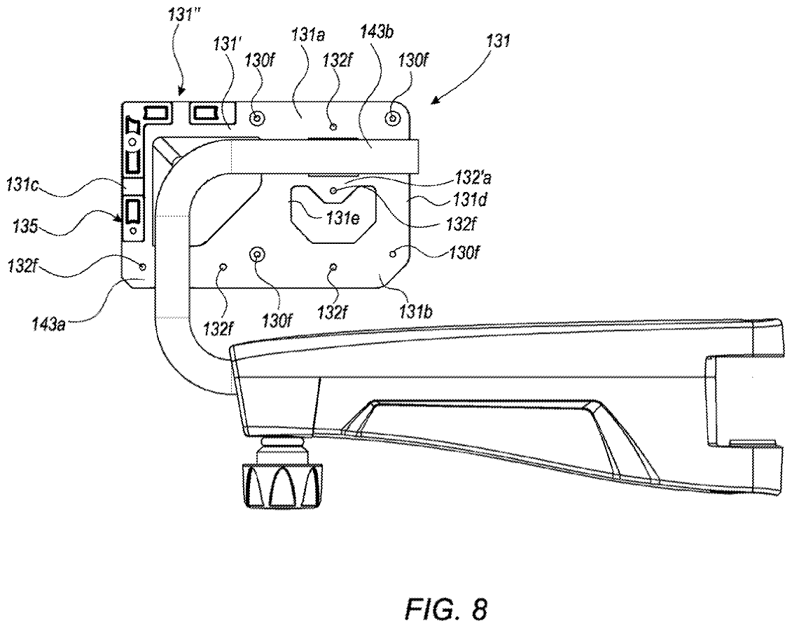

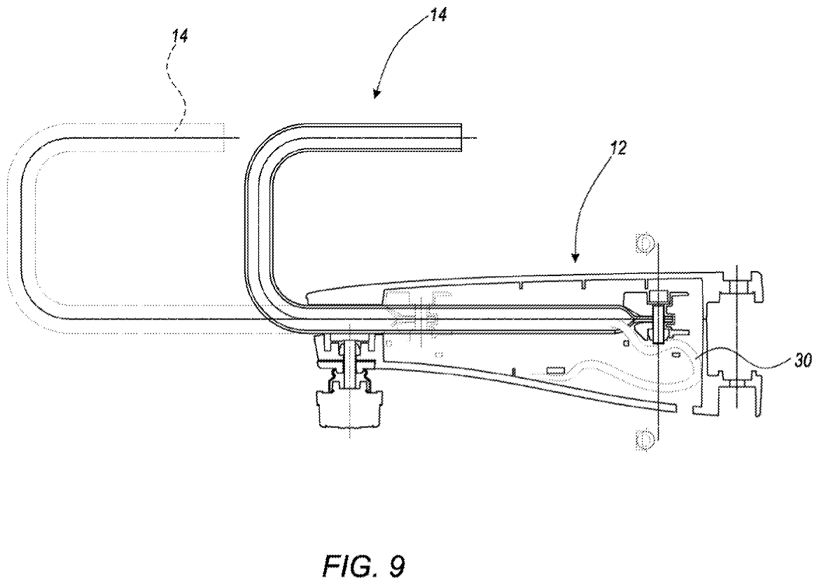

In an advantageous manner, as is inferred from FIGS. 5 and 8, said first and said second parts 131, 132 of said means or block 13 for supporting said signaling means 11, have corresponding faces, in particular flat 131′, 132′ adapted to be counterfacing and joined together.

With advantage, as is inferred from FIGS. 5 and 8, said first and said second part 131, 132 of said means or block 13 for supporting said signaling means 11, have corresponding faces or surfaces 130s, 130s opposite said faces 131′, 132′ which are adapted to be counterfacing and joined together, and such opposed faces or surfaces 130s, 130s are adapted to receive a corresponding signaling panel 111 in engagement.

With particular advantage, as is inferred from FIGS. 5 and 8, said seat means of said means or block 13 for fixing said signaling means 11, which are adapted to receive said support arm 141, comprise a first seat 143a for the perpendicularly protruding portion or branch 142a of the same arm 141 and a second seat 143b for the portion or branch 142b returned backward, in particular extending from said perpendicularly protruding portion or branch 142a.

In an advantageous manner, as is inferred from the FIGS. 5, 7A and 8, said seat means for said coupling means 142 of said support arm 141, in particular the first seat 143a for receiving the perpendicularly protruding portion or branch 142a of the same support arm 141 and/or the second seat 143b for receiving the portion or branch 142b returned backwards, are defined respective semicircular surfaces 143a, 143a and/or 143b, 143b, mutually counterfacing, respectively provided on said first 131 and on said second 132 part of said means or block 13 for fixing said signaling means 11.

Advantageously, as is inferred from FIGS. 5 and 8, said first seat 143a for the perpendicularly protruding portion 142a is extended perpendicularly, i.e. it has a respective perpendicular axis, and in particular is provided on the longitudinal elements 131b, 132b, in particular lower in use, of said first and second part of said means or block 13 for supporting said signaling means 11, and is provided in particular on a corresponding protruding portion 132′b of the longitudinal element 132b of the second part 132, which is extended with respect to the perpendicular end element 132c counterfacing the intermediate perpendicular element 131e of the first part of said means or block 13 for supporting said signaling means 11.

With advantage, as is inferred from the figures, said second seat 143b for the returned backwards portion or branch 142b extends longitudinally, in particular for a length section corresponding to the width of the main part of the second part 132 of said means or block 13 for supporting said signaling means 11. Said second seat 143b preferably is provided on the longitudinal elements 131a, 132a of said first and second part 131, 132 of said means or block 13 for supporting said signaling means 11, in particular on a lowered portion 131′a, 132′a of these longitudinal elements 131a, 132a of said first and second part 131, 132.

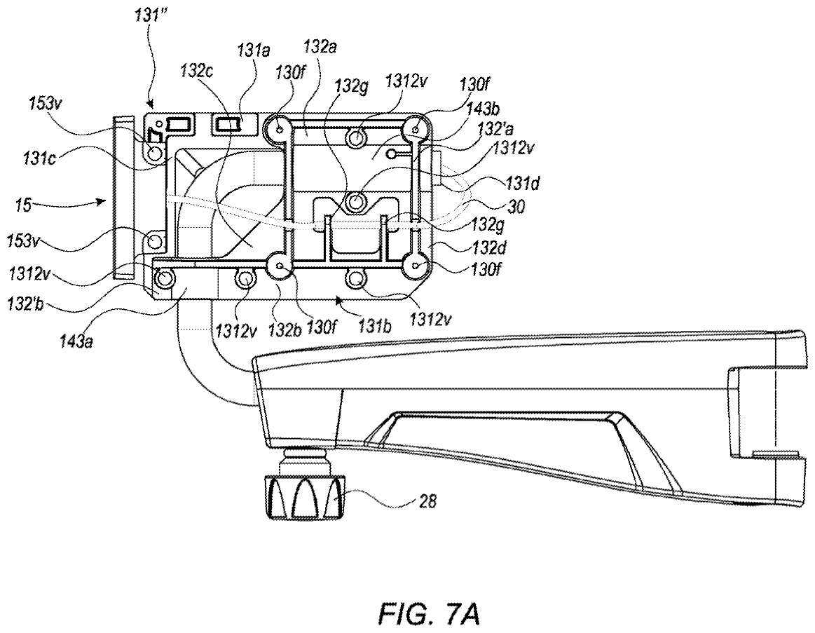

In an advantageous manner, as is inferred from FIGS. 7A and 8, said first part 131 of said means or block 13 for supporting said signaling means 11 has a portion 131″ which protrudes with respect to the second part 132 of the same means or block 13, for supporting said signaling means 11, and such protruding portion 131″ defines a seat 135 for housing said element or block 15 for supporting said emission means of a light radiation, preferably said seat being defined by a respective face or surface, especially flat, of the corresponding perpendicular end element 131c of said first part 131.

With particular advantage, as is inferred from the figures, means 131f, 132f, 1312v are provided for joining said first and second counterfacing parts of said means or block 13 for supporting said signaling means 11.

With advantage, as is inferred from the figures, said means for joining said first and second counterfacing parts of said means or block 13 for supporting said signaling means 11, comprise corresponding holes 131f, 132f in said first and second part 131, 132 of the same means or block 13 for supporting said signaling means 11, and corresponding joining screws 1312v are inserted in such holes 131f, 132f.

In particular, respective first and second holes 131f, 132f and 131f, 132f for corresponding first and second screws 132v, 132v are provided at both sides of the respective seat, in particular of the first and second seat 143a, 143b for housing the corresponding portion or branch 142a, 142b of said coupling means of said support arm 143.

Advantageously, said means or block 13 for fixing said signaling means 11 define means 132g for guiding and supporting a cable 30 for supplying electric power to said emission means of a light radiation, in particular provided on said second part 132 of said means or block 13 for supporting said signaling means 11.

Advantageously, said means for guiding and supporting a cable 30 for supplying electric power to said emission means of a light radiation comprise a respective hook element, preferably a first and a second hook element 132g, 132g, longitudinally spaced apart.

Said hook element 132g is preferably provided, or accessible, from the face of the same second part 132 of said means or block 13 for supporting said signaling means 11 which faces towards the corresponding signaling panel 111 fixed thereto.

Advantageously, the device 1 is movable between an operative signaling position and a rest position, and vice versa, in particular said device 1 being movable, especially rotatable, between an operative position transverse to the vehicle and a rest position longitudinal to the same vehicle, and vice versa.

In this manner, the device can be easily arranged in a position in which it does not cause encumbrance, in particular with regard to the vehicle driving operations, when it no longer needs to be used.

In an advantageous manner, as is inferred from the figures, said means 10 which connect said signaling means 11 to the same vehicle are rotatably connected, in particular rotatably with respect to a corresponding perpendicular or vertical axis R to the same vehicle.

As illustrated, said means 10 which connect said signaling means 11 to the same vehicle also comprise means 16 which are adapted to movably connect said means 14 for supporting the signaling device to said means 12 for connecting to said vehicle.

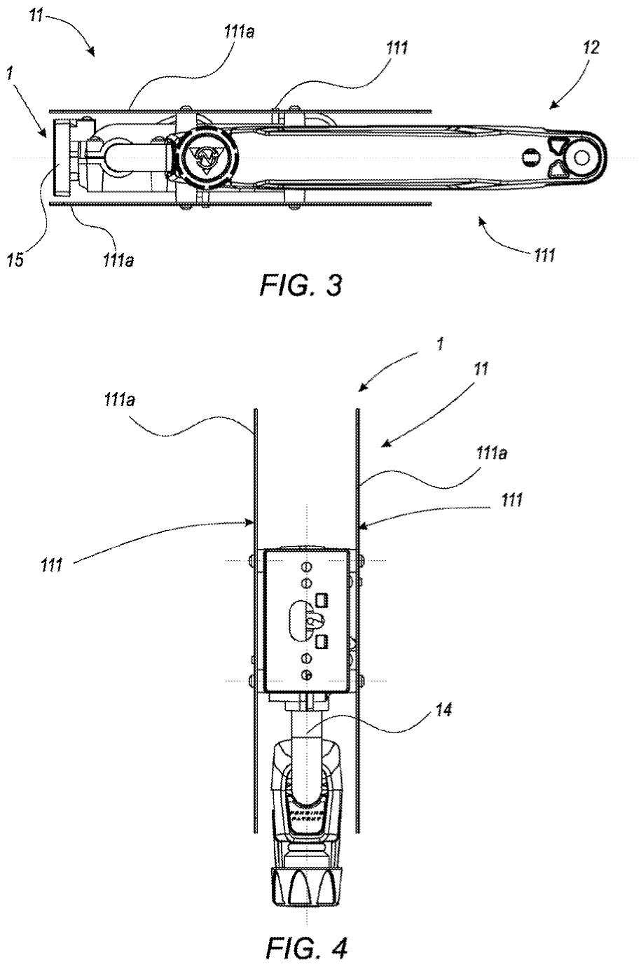

As is inferred from FIG. 3A, said connecting means 16 are adapted to allow said means 14, for supporting the device, to be moved into any one position comprised between a respective retracted position, respective to said means 12 for connecting to the vehicle, in particular in which the signaling device 10 is maximally close to said vehicle, and a respective extended position, with respect to the same connecting means 12, in particular in which the same signaling device 10 is maximally distanced from the same vehicle.

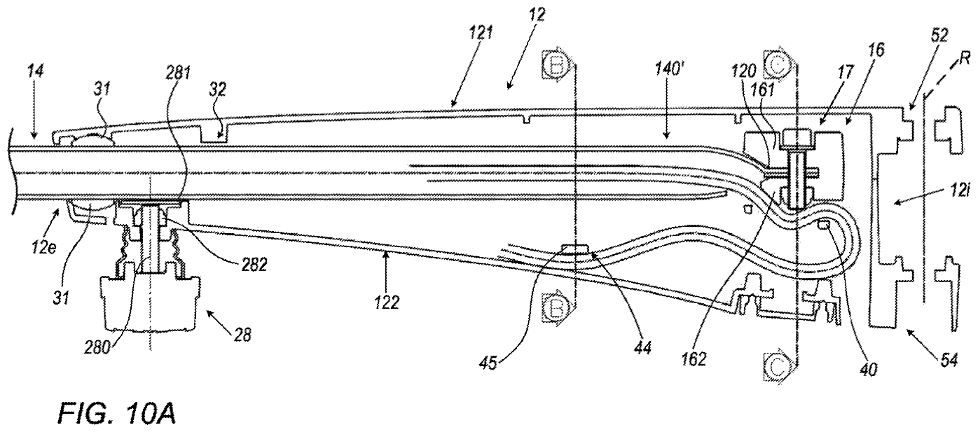

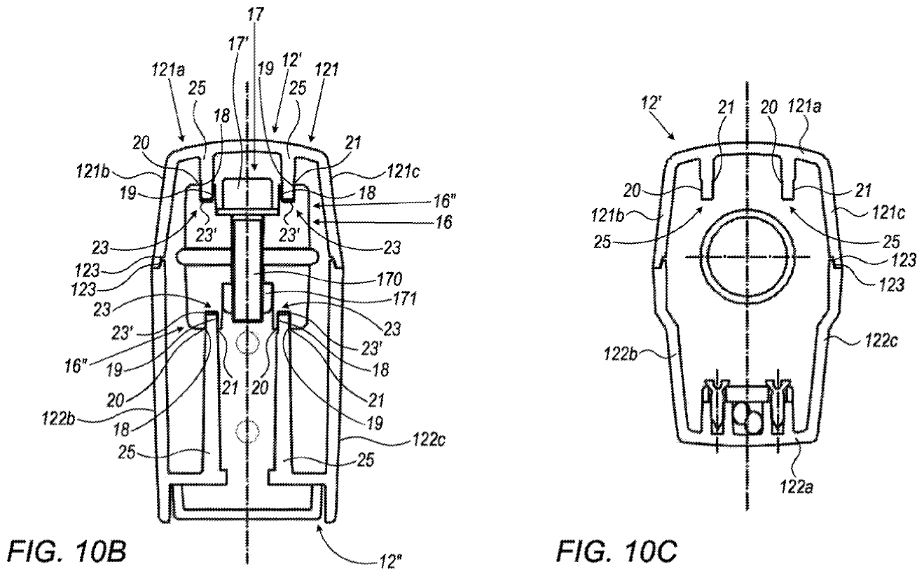

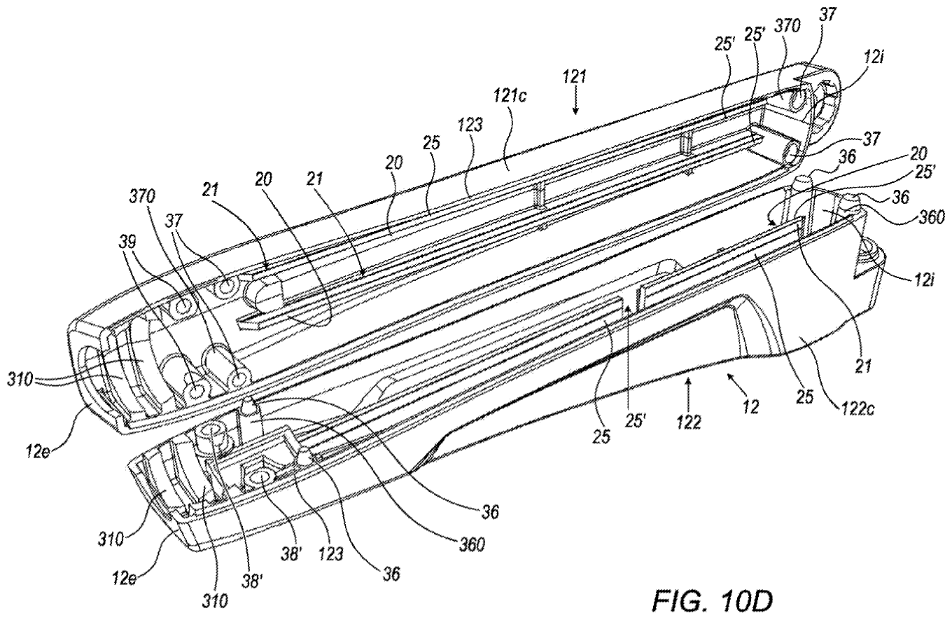

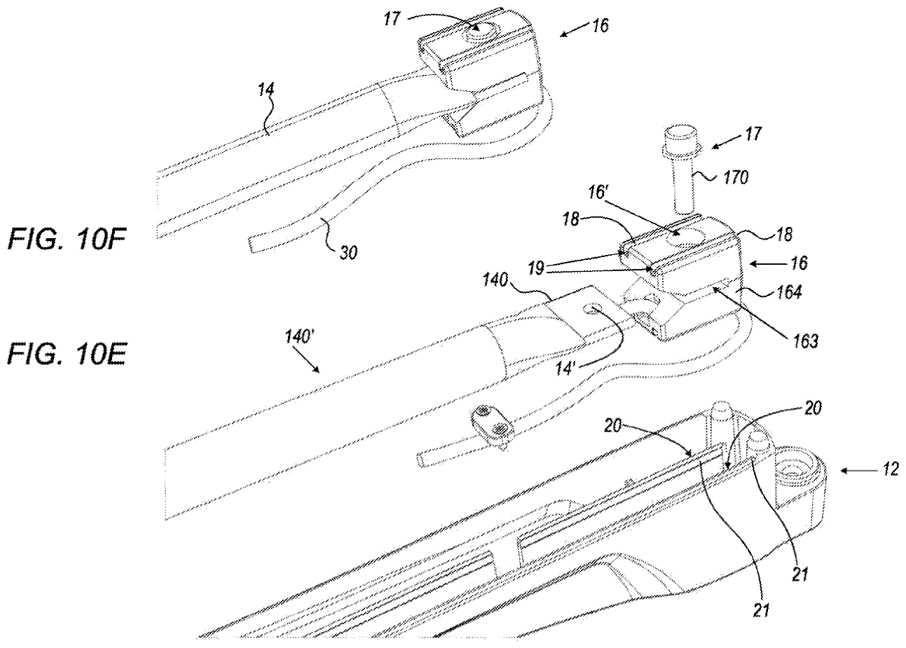

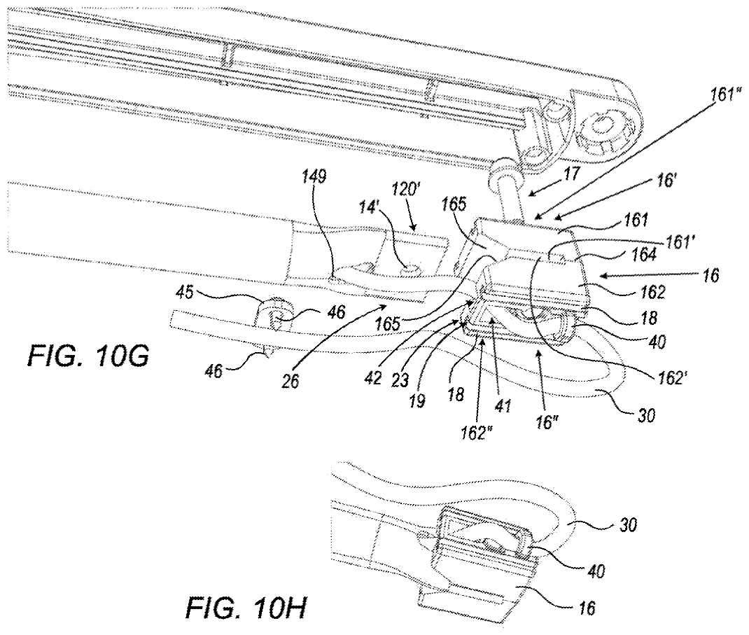

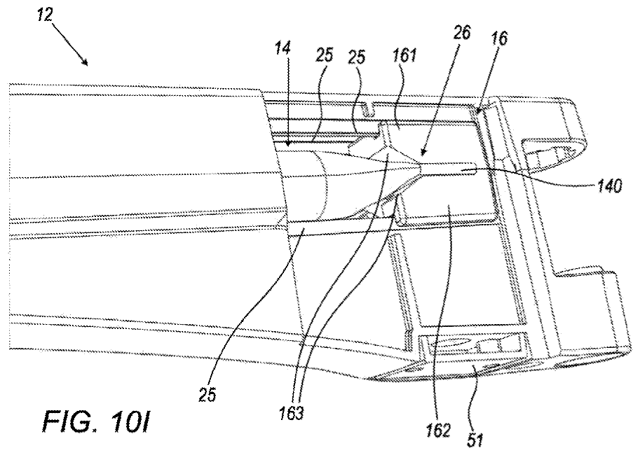

Advantageously, as is inferred in particular from FIG. 10B, said connecting means 16 have a plurality of pairs of surfaces 18, 19 of slidable engagement with corresponding pairs of surfaces 20, 21 of the means for connecting to the vehicle.

In this manner, it is possible to minimize the presence of clearances between the means for supporting the signaling device and means for connecting or fixing to the vehicle, and the vibrations that the signaling device can have when the vehicle is moving or running are considerably reduced.

Advantageously, as is inferred from the figures, the means 12 for connecting to the vehicle, are preferably in the form of a respective body, having a first part 121, in particular upper in use, and a second part 122, in particular lower in use, which are mutually counterfacing and define a respective housing chamber for said connecting means 16 and for a corresponding end portion 140′ of the means 14 for supporting the device.

In particular, as is inferred in particular from FIGS. 4 and 5, the respective part 121, 122 of the body 12 has a respective bottom wall 121a or 122a, upper and/or lower in use, from which corresponding lateral walls 121b, 121c or 122b, 122c are extended in use that are mutually counterfacing at the respective perpendicular or free edges 123.

Advantageously, as is inferred from the figures, a plurality of pairs of surfaces 18, 19, in particular two pairs of surfaces 18, 19 of slidable engagement with corresponding pairs of surfaces 20, 21, of the means for connecting to the vehicle 12, are provided at the side or upper part of said connecting means 16.

With advantage, as is inferred from the figures, a plurality of pairs of surfaces 18, 19, in particular two pairs of surfaces 18, 19 of slidable engagement with corresponding pairs of surfaces 20, 21 of the means for connecting to the vehicle, are provided at the side or lower part of said connecting means 16.

In practice, as is inferred from the figures, a plurality of pairs of surfaces, in particular two pairs of surfaces 18, 19 of slidable engagement with corresponding pairs of surfaces 20, 21, of the means for connecting to the vehicle 12, are provided in a respective semi-portion, in particular at a respective side or part, of said connecting means 16.

In practice, as illustrated, two pairs of surfaces 18, 19 are provided on the side or upper part of the connecting means or body 16, and two pairs of surfaces 18, 19 on the side or lower part of the same connecting means or body 16.

In this manner, it is possible to minimize the presence of clearances between the means 14 for supporting the signaling device and the means 12 for connecting or fixing to the vehicle, and the vibrations that the signaling device can have when the vehicle is moving or running are considerably reduced.

Advantageously, as is inferred from the figures, the surfaces 18, 19 of each pair of surfaces of slidable engagement on said connecting means 16 face in opposite directions, in particular transversely opposite each other.

In an advantageous manner, as is inferred from the figures, the surfaces 18, 19 of each pair of surfaces of slidable engagement on said connecting means 16 are mutually counterfacing, in particular transversely counterfacing each other.

Advantageously, as is inferred from the figures, the surfaces 20, 21 of each pair of corresponding surfaces of slidable engagement of the means for connecting to the vehicle 12 face in directions, in particular transverse, opposite each other and preferably face towards corresponding lateral flanks of said means for connecting to the vehicle 12, and especially being adapted to engage the surfaces 18, 19 of the respective engagement and sliding pair counterfacing each other.

With advantage, as is inferred from the figures, in use, the surfaces 18, 19 of each pair of surfaces of slidable engagement on said connecting means 16, and/or the corresponding pairs of surfaces 20, 21 of the means for connecting to the vehicle 12, are transversely aligned with each other.

In an advantageous manner, as is inferred from the figures, and as described above, on the connecting means 16, two pairs of surfaces 18, 19 of slidable engagement are provided at the upper part 121 of said connecting means 12.

As is inferred from the figures, therefore, on the means for connecting to the vehicle 12, two pairs of corresponding surfaces 20, 21 of slidable engagement are provided at the lower part 122 of said connecting means 12.

With advantage, as is inferred from the figures, and as described above, on the connecting means 16, two pairs of engagement and slide surfaces 18, 19 are provided at the lower part 122 of said connecting means 12.

As is inferred from the figures, therefore, on the means for connecting to the vehicle 12, two pairs of corresponding surfaces 20, 21 are provided for engaging and sliding at the lower part 122 of said connecting means 12.

In a particularly advantageous manner, as is inferred from the figures, said connecting means comprise, or consist of, a shaped corresponding body 16, preferably made of plastic material, especially having a general prismatic shape.

Advantageously, as is inferred from the figures, in order to connect said means 12 for connecting to said vehicle and said means 14 for supporting the signaling device, a plurality of receiving seats 23 are provided for corresponding protrusions 25.

In an advantageous manner, as is inferred from the figures, said receiving seats 23 are provided in said shaped connection body 16 and said protrusions being provided on said means, or arm, 12 for connecting to the vehicle, in particular on said first 121 and second 122 parts thereof.

With advantage, as is inferred from the figures, a plurality of receiving seats, in particular two receiving seats 23 for corresponding protrusions 25 is provided at a respective side, or part, in particular upper 16′ and/or lower 16″, of said connecting means or body 16.

Advantageously, as is inferred from the figures, a plurality of protrusions, in particular two protrusions, 25 are extended from the respective side, in particular upper 12′ and/or lower 12″, of said means 12 for connecting to the vehicle, or from the respective upper part 121 or lower part 122.

Advantageously, as is inferred from the figures, the respective protrusion 25, or the respective pair of protrusions 25, 25, is extended or are extended, in particular perpendicularly, from the bottom wall 121a or 122a of the respective upper part 121 or lower part 122 of said means 12 for connecting to the vehicle.

With advantage, as is inferred from the figures, the respective protrusion 25, or the respective pair of protrusions 25,25 is extended or are extended, longitudinally for a main part of the length of said means 12 for connecting to the vehicle, or of the respective part 121 or 122 of said means 12 for connecting to the vehicle, and in particular for a length greater than half of the length of said means 12 for connecting to the vehicle, or of the respective part 121 or 122 of said means 12 for connecting to the vehicle.

In practice, the respective seat 23 comprises opposed surfaces, in particular lateral and mutually counterfacing 18, 19, of slidable engagement with surfaces, in particular lateral, 20, 21 of the corresponding protrusion 25.

As illustrated, said surfaces 20, 21 of the corresponding sliding protrusion 25 are provided at a respective end portion, i.e. at the free end, of the same protrusion 25.

The respective seat 23 also has a respective bottom wall 23′, from which said slidable engagement surfaces 18, 19 are extended, preferably perpendicularly, which are of possible slidable engagement for the end edge 25′ of the respective protrusion 25.

Advantageously, as is inferred from the figures, means 26 are provided for firm fixing of said connecting means or body 16 to said means 14 for supporting the signaling device.

In this manner, it is possible to further minimize the presence of clearances and the vibrations that the signaling device can have when the vehicle is moving or running are considerably reduced.

With advantage, as is inferred from the figures, said firm fixing means 26 comprise respective tab means 140 which are inserted within a corresponding gripping means 161, 162.

In particular, as is inferred from the figures, said tab means comprise a respective enlarged tab 140, which is extended from the free end of said means 14 for supporting the signaling device.

In particular, as illustrated, in use, said fixing tab 140 is arranged horizontally or substantially horizontal.

Advantageously, as is inferred from the figures, said gripping means comprise a first and a second opposite portion 161, 162 of said connecting means or body 16, and such portions 161, 162 are adapted to receive and clamp together said tab means 140, which are extended from said means 14 for supporting the signaling device.

With advantage, as is inferred from the figures, means 17 are provided for coupling said connecting means or body 16 to said means 14 for supporting the signaling device.

Preferably, as is inferred from the figures, said means for coupling said connecting means or body 16 to said means 14 for supporting the signaling device comprise a corresponding stem 170, in particular the stem of a corresponding screw 17, with enlarged head 17′, which is stopped by a corresponding nut 171, which is inserted within a corresponding hole 14′, 16′ provided in said means 14 for supporting the signaling device and in said connecting means or body 16.

In particular, a corresponding hole 16′ is provided in the respective gripping portion 161 or 162 of said connecting means or body 16 and a corresponding hole 14′, is provided in the tab portion 140 of said means 14 for supporting the signaling device.

Advantageously, as is inferred from the figures, means are provided for clamping said first and second opposite portions 161, 162 of said connecting means or body 16 against the corresponding tab 140 extended from said means 14 for supporting the signaling device.

In particular, as is inferred from the figures, said coupling means 17 define said means for clamping said first and second opposite portions 161, 162, of said connecting means or body 16 against the corresponding tab 140 extended from said means 14 for supporting the signaling device.

In a further advantageous manner, as is inferred from the figures, said insertion tab 140 is defined by a crushed end portion of said means 14 for supporting the signaling device.

In practice, as is inferred from the figures, said connecting means or body 16 have a first and a second portion 161, 162 together defining a respective slit 163 for receiving the respective tab 120.

As is inferred from the figures, said first and second portion 161, 162 of said connecting means or body 16 are connected to each other through a connection portion 164, in particular from which said first and second portions 161, 162 are extended cantilevered, and which allows said first and second portions 161, 162 to be close to each other, in particular in a bending manner, i.e. due to elastic yielding, in order to engage, with the corresponding surfaces 161′, 162′, the opposite faces 120′, 120″ of the corresponding inserted tab or end portion of said means 14 for supporting the signaling device.

Advantageously, as is inferred from the figures, said connecting means or body 16 have a first and a second opposite external face 161″, 162″, at which respective surfaces 18, 19 are provided, which are provided on the same connecting means 16 for the slidable engagement of said means for connecting to said vehicle 12, i.e, of the corresponding receiving seats 23 for corresponding protrusions 25 of said means for connecting to said vehicle 12.

Said opposed external faces 161″, 162″ are preferably parallel to said internal surfaces 161′, 162′ of said first and second portion 161, 162 of said connecting means or body 16 which are for engaging the corresponding insertion tab or end portion 140 of said means 14 for supporting the signaling device.

With advantage, as is inferred from the figures, said first and second gripping portion 161, 162 have end surfaces that are mutually counterfacing 165, 165, which diverge from each other in order to house a corresponding convergent portion of said connecting means or body 16, which supports, or is upstream, of said insertion end portion or tab.

In an advantageous manner, as is inferred from the figures, means 28 are also provided for blocking, in the respective work position, said means or arm for supporting the signaling means 11 with respect to said means for connecting to said vehicle 12, in particular said blocking means 28 being provided in proximity to the free end of said means 12 for connecting to said vehicle.

With advantage, as is inferred from the figures, said means for blocking said means or arm for supporting the signaling means 11 are engageable on the same means or arm for supporting the signaling means 11 in order to block them in the respective work position and they are disengageable therefrom in order to release them and allow the same means or arm, for supporting the signaling means 11, to freely slide with respect to the means for connecting to the vehicle 12.

Advantageously, as is inferred from the figures, said means for blocking said means or arm for supporting the signaling means 11 with respect to said means for connecting to said vehicle 12, comprise respective actuation means, in particular in the form of a knob 28, which are supported, especially in a freely screwable and unscrewable manner, by said means for connecting to said vehicle 12 and can be actuated, in particular manually, in an action of engagement or blocking of said means or arm for supporting the signaling means 11 and respectively in an action of disengagement and release of the same means or arm for supporting the signaling means 11.

In an advantageous manner, as is inferred from the figures, said actuation means or knob 28 have a respective shank 28 that engages, i.e. whose free end engages, preferably with movement in perpendicular direction, a corresponding shaped and elongated plate 281, in particular with curved shape, for in turn engaging said means 14 for supporting the signaling device and distributing force thereon.

In particular, said shaped plate 281 is housed within said means for connecting to said vehicle 12, especially in the lower part 121 thereof, and has a respective hollow tube 282, in particular perpendicularly extended with respect to said plate 281, which is adapted to receive said engagement shank 280.

Advantageously, as is inferred from the figures, means 31 are also provided for sliding said means 14 for supporting the signaling device with respect to said means for connecting to said vehicle 12, in particular situated at the free end of said means 12 for connecting to said vehicle 28, especially downstream of said engagement means that are blocking said means 14 for supporting the signaling device.

Said sliding means 31 are provided in proximity to the end wall 12e of said means for connecting to said vehicle 12, i.e. the perforated exit wall 12e for said means 14 for supporting the signaling device, which is opposite the transverse wall 12i at the other side of the same means for connecting to said vehicle 12.

In particular, as is inferred from the figures, said means 31 for sliding said means 14 for supporting the signaling device with respect to said means for connecting to said vehicle 12 comprise a first and a second semi-element, or semi-rings, 31, 31, which peripherally engage on sides opposite said connecting means or body 16.

Said first and second part 121, 122 of said means for connecting to said vehicle 12 have corresponding shaped seats 310, in particular semi-annular, for the abutment of corresponding semi-elements or semi-rings 31, 31.

In particular, said shaped seats 310 are provided downstream of the zone provided for said means 28 for blocking said means or arm for supporting the signaling means 11 at said means for connecting to said vehicle 12.

Advantageously, as is inferred from the figures, means 36, 37, 38, 39 are provided for attaching together said first 121 and second 122 parts of said means for connecting to said vehicle.

With advantage, as is inferred from the figures, said attachment means between said first 121 and second 122 parts of said means for connecting to said vehicle 12 comprise corresponding pintle means 36, in particular with conical shape, which are inserted in corresponding housings 37, in particular said pintle means 36 and/or said housings 37 being provided at the end of corresponding column elements 360, 370, which are extended from the corresponding part 121 and/or 122 of said means for connecting to said vehicle 12, especially from the bottom wall 121a, 122a of the respective part 121 and/or 122 of said means for connecting to said vehicle 12.

In particular, as illustrated, a pair of pintle elements 36, 36 is provided which are inserted in a corresponding pair of housings 37, 37, which are at one end, in particular upstream, of said means for connecting to said vehicle 12.

In addition, a second pair of pintle elements 36, 36 is also provided which are inserted in a corresponding pair of housings 37, 37, and which are in proximity to the opposite end, or downstream end, of said means for connecting to said vehicle 12, especially being arranged at, or laterally with respect thereto, said means 28 for blocking, in the respective work position, said means or arm for supporting the signaling means 11.

In this manner, it is possible to connect together said first 121 and second 122 part of said means for connecting to said vehicle 12 in a particularly quick and easy manner.

In an advantageous manner, as is inferred from the figures, said means for attaching said first 121 and second 122 part of said connecting means also comprise screw joining means 38, in particular in the form of a first and a second screw 38, 38, which are inserted in corresponding through holes 38′, 38′ of a respective part 122 of said means for connecting to said vehicle 12 and which are screwed in corresponding threaded holes 39, 39 at the other part 121 of said means for connecting to said vehicle 12.

Preferably, said through and threaded holes 38′, 39 are provided at, or in proximity to the means 28 for blocking, in the respective work position, said means or arm for supporting the signaling means 11, preferably laterally with respect thereto, and/or in particular downstream of the corresponding pins and attachment housings 36 and 37.

Advantageously, as is inferred from the figures, said longitudinal protrusions 25 for sliding said connecting means or body 16, which are provided on the respective part 121 and/or 122 of said means for connecting to said vehicle 12, are extended longitudinally starting from the columns 360, 370 for the attachment means at one end, in particular upstream, of said means for connecting to said vehicle 12, up to reaching in proximity to the columns 360, 370 for the attachment means at the other end, in particular downstream, of the same means for connecting to said vehicle 12.

In an advantageous manner, as is inferred from the figures, means 32 and/or 34 are provided for stopping the travel of said connecting means 16 in the respective work position, in particular in the retracted position, in particular in which the signaling device 10 is maximally close to said vehicle, and/or in the extended position, in particular in which the same signaling device 10 is maximally distanced from the same vehicle

With advantage, as is inferred from the figures, said means 32 and/or 34 for stopping the travel of said connecting means 16 in the respective work position are provided on said means for connecting to said vehicle 12, in particular on the upper part 121 and/or on the lower part 122 thereof.

With advantage, as is inferred from the figures, said means for stopping the travel said connecting means 16, in particular in the respective extended work position of said means 14 for supporting the signaling device, are defined by a corresponding engagement stud 32, which is preferably provided protruding from said upper part 121 of said means for connecting to said vehicle 12, in particular from the bottom wall 121a thereof, and which is extended between said protrusions 25 for slidable engagement of said connecting means or body 16.

Preferably, said engagement stud 32 is situated upstream of said means 31 for sliding said means 14 for supporting the signaling device with respect to said means for connecting to said vehicle 12 and/or said means for blocking said means or arm for supporting the signaling means 11, or said means 36, 37, 38, 39 for attaching said first 121 and second 122 part of said means for connecting to said vehicle 12, and which are at the free end thereof.

Advantageously, as is inferred from the figures, said means for stopping the travel of said connecting means 16 in the respective retracted work position are defined by one or more corresponding columns 360 or 370 for corresponding attachment means 36 and/or 37 between said first 121 and second 122 part of said means for connecting to said vehicle 12 and which are arranged at one end, in particular upstream, of said means for connecting to said vehicle 12.

In an advantageous manner, as described above, means are provided for supplying an electric current, in particular in the form of a respective electrical cable 30.

Advantageously, as is inferred from the figures, said connecting means or body 16 have means 40 for retaining said means, or electrical power supply cable 30.

In this manner, said electrical power supply means or cable 30 can be easily moved, i.e. extended or retracted, without risk of jamming, together with the movement of said means for supporting the signaling device.

Advantageously, as is inferred from the figures, said means for retaining said electrical power supply means or cable 30 are extended at a corresponding face, in particular lower in use, of said connecting means or body 16 and, preferably, comprise a corresponding ring element 40 for inserting and retaining said electrical power supply cable 30.

With advantage, as is inferred from the figures, said connecting means or body 16 comprise a corresponding seat or channel 41 for storing said electrical power supply means or cable 30, and such storage seat or channel 41 is at a corresponding face, in particular lower in use, of said connecting means or body 16 and leads into a corresponding hole 42 for passage of said electrical power supply cable 30, which, preferably, corresponds with, or faces, in use, a corresponding hole 149 that is provided on said means, or arm, for supporting the signaling means 11, in particular on a tilted face thereof, and through such hole 149 said cable passes into said means, or arm, for supporting the signaling means 11.

As illustrated, said storage seat or channel 41 is situated between corresponding longitudinal seats 23 for slidable engagement which are provided on the respective face, in particular lower in use, of said connecting means or body 16.

In an advantageous manner, as is inferred from the figures, means 44 are provided for stopping the electrical power supply means or cable 30 on the means 12 for connecting to said vehicle, in particular at the lower part 122 thereof, and such stopping means 44 are preferably provided between the end positions—in particular longitudinally opposed—which said connecting means or body 16 take on at respectively said retracted and extended positions of said means 14 for supporting the signaling device.

Advantageously, as is inferred from the figures, said means 44 for stopping electrical power supply means or cable 30 on the means 12 for connecting to said vehicle comprise a member or plate 45 for engaging and clamping the same electrical power supply means or cable 30 against said means for connecting to said vehicle 12, or against a wall, in particular bottom or lower 122a of the respective part, in particular lower 122 of the same means for connecting to said vehicle 12.

As illustrated, screw means are provided, i.e. in the form of first and second screws 46, 46 which clamp the member or plate 45 for engaging and clamping the same electrical power supply means or cable 30 towards and against said means for connecting to said vehicle 12, i.e. against the wall, in particular bottom or lower, 122a of the respective part, in particular lower 122 of the same means for connecting to said vehicle 12.

With advantage, as is inferred from the figures, said member or plate 45 for engaging and clamping the same electrical power supply means or cable 30 is extended, in particular transversely, fitting into at least one corresponding split 25′, provided in a corresponding longitudinal protrusion 25, or in corresponding splits 25′ provided in both adjacent longitudinal protrusions 25, 25 for sliding said connecting means or body 16, and such respective protrusion is in particular provided on the respective part, in particular lower 122, of said means for connecting to said vehicle 12.

In particular, said connecting means or body 16 has a longitudinal length which is greater than the longitudinal extension of the respective split 25′, in this case allowing to easily move beyond, without jamming, the same split by the same connecting means or body 16, while this is moved along the respective protrusion

As is inferred from the figures, said means for connecting to the vehicle 12 comprise means 52, 54 for a fixing, in particular hinge fixing, preferably directly to the vehicle.

In particular, said means for connecting to said vehicle 12 define a corresponding hinge end joint, preferably for rotating around a vertical axis. In particular, a through hole is provided at the upper part of the body 12 for connecting to the vehicle and a corresponding through hole is provided at the lower part of the same body 12 of connection to the vehicle.

As is inferred from the figures, said means for connecting to the vehicle 12 comprise means protruding from the end, in particular upstream, of the same means for connecting to said vehicle 12, and especially comprise a first and second portion 52, 54 protruding from the end wall 12 of the respective upper part and lower part 121, 122 of said means for connecting to said vehicle 12, and such protruding means or portions such as protruding means or portions 52, 54 comprise a corresponding through hinging hole, preferably for hinging directly to the vehicle.

Advantageously, as illustrated, said means or recess 50 for arranging corresponding illumination means are in vicinity to one end of the same means for connecting to said vehicle 12.

In addition, as illustrated, said means or recess 50 have a respective bottom in which a hole is provided for the passage of a corresponding electrical power supply cable.

In practice, as is evident, the above-illustrated technical characteristics allow —separately or in respective combination—attaining one or more of the following advantageous results:

it is possible to use the same device for different use situations, in particular for different types of vehicles;

a firm and strong support is obtained, for the corresponding signaling panel;

it is possible to prevent the assembly of the respective signaling panel from taking place in an incorrect manner, with the need to have to remake said assembly, or even worse, a vehicle would result that travels in a manner not compliant with the law;

it is also possible to easily arrange, on the device, means which are adapted to emit a corresponding light radiation;

it is possible to use elements for supporting different types of means which are adapted to emit a corresponding light radiation;

it is possible to arrange said signaling means in an appropriate height position with respect to the load and to the vehicle;

it is possible to easily arrange the device in a position where it does not cause encumbrance, in particular to the vehicle driving operations, when it no longer needs to be used.

The present invention is susceptible of clear industrial application. The man skilled in the art can also devise numerous modifications and/or variations to be made to the same invention, even if remaining within the scope of the inventive concept, as described in detail above. In addition, the man skilled in the art can devise further preferred embodiments of the invention which comprise one or more of the above-illustrated characteristics of the preferred embodiment. In addition, it must be intended that all the details of the invention can be substituted by technically equivalent elements.

1.-50. (canceled)

51. The device for signaling a vehicle encumbrance, in particular for a transverse encumbrance of said vehicle, in particular usable on agricultural and/or forestry machinery or for signaling a load protruding from said vehicle, comprising means for signaling the overall dimensions and means which connect said signaling means to the same vehicle; wherein said means which connect said signaling means to the same vehicle are adapted to support said signaling means in respective positions, in particular transversal with respect to the same vehicle, said positions being comprised between a maximum extension position and a minimum extension position with respect to said vehicle.

52. The device according to claim 51, wherein said means which connect said signaling means to the same vehicle comprise, or consist of, an extensible support, in particular, in use, extensible transversely to the vehicle, such an extensible support is especially suitable for arranging said signaling means between said maximum extension position and said minimum extension position with respect to the same vehicle.

53. The device according to claim 51, wherein said signaling means comprise at least a corresponding signaling panel, especially having a respective retro-reflective face and/or signaling strips, and in particular facing, in use, transversely with respect to a corresponding longitudinal direction of the vehicle, and preferably comprise first and second panels, especially retro-reflective and/or signaling strips, which face in opposite directions, in particular facing transversely with respect to opposite longitudinal directions of the vehicle.

54. The device according to claim 53, wherein the respective signaling panel is in the form of a thin metal or plastic plate, in particular having a respective retro-reflective surface, especially in strips, preferably oblique, and preferably in alternate strips of white and red color.

55. The device according to claim 51, wherein said signaling means comprise means for emitting a light radiation, preferably means for emitting a light radiation, in use, protrude, in particular laterally, with respect to the corresponding signaling panel, or with respect to said first and second signaling panels, preferably on the side of the panel which is opposite that facing the vehicle.

56. The device according to claim 51, wherein means are provided to support said signaling means, or the respective signaling panel and/or said emission means of a light radiation, on said means or support for connecting to the vehicle.

57. The device according to claim 56, wherein said means supporting said signaling means on said means or support for connecting to the vehicle comprise a support block.

58. The device according to claim 56, wherein said support means or block have a configuration, in particular a general prismatic configuration, which is adapted to define for the respective signaling panel a corresponding engagement surface; in particular, said support means having opposite first and second engagement surfaces for said first and second signaling panels; preferably said block, at the respective engagement surface having an extension of the respective side which is greater than at least the fourth part of the length of the corresponding side of said signaling panel.

59. The device according to claim 53, wherein means are provided which are adapted to allow the assembly with correct orientation of the corresponding signaling panel; said adapted to allow the assembly with correct orientation of the corresponding signaling panel comprise a corresponding insertion hole for a corresponding screw or pin, only when the respective panel is in the correct mounting position.

60. The device according to claim 51, wherein the respective signaling panel comprises four holes for inserting corresponding attachment screws, such four holes are arranged at the vertices of a corresponding virtual square; a fifth hole being provided in said signaling panel for the insertion of a corresponding screw or pin, defining said mounting means with correct orientation of the corresponding signaling panel, said fifth hole being provided on the virtual diagonal between two holes at the vertices of said virtual square, said fifth hole provided on the diagonal being in greater proximity to one of said opposed holes between which the same virtual diagonal extends.

61. The device according to claim 55, wherein an element is provided which is adapted to support said emission means of a light radiation.

62. The device according to claim 61, wherein said element which is adapted to support said emission means of a light radiation is engageable to and disengageable from said means or block for fixing said signaling means.

63. The device according to claim 51, wherein said means or support for connecting said signaling means to said vehicle comprise connecting means to said vehicle and means for supporting said signaling means.

64. The device according to claim 63, wherein said means for supporting said signaling means are extendable, or movable, with respect to said means for connecting to said vehicle, so as to arrange said signaling means between said maximum extension position and said minimum extension position with respect to the same vehicle, in particular wherein said means for supporting said signaling means comprise a corresponding arm, which carries said signaling means, such an arm is slidable or movable with respect to said means for connecting to said vehicle.

65. The device according to claim 64, wherein said arm, which carries said signaling means, is in the form of an elongated element, preferably in the form of an elongated tubular element, having a respective free end for supporting said signaling means.

66. The device according to claim 65, wherein said means for connecting with said means or block for fixing said signaling means comprise a portion or branch of said support arm, which has returned backwards, in particular extending from said portion, or branch, protruding perpendicularly and which is in particular parallel to the main longitudinal branch of the same support arm.

67. The device according to claim 56, wherein said means or block for supporting said signaling means comprise a first and a second distinct part which are counterfacing and joined together.

68. The device according to claim 51, wherein said means or block for fixing said signaling means define means for guiding and supporting a cable for supplying electric power to said emission means of a light radiation, in particular provided on said second part of said means or block for supporting said signaling means.

69. The device according to claim 68, wherein said guiding and support means for a cable for supplying electric power to said emission means of a light radiation comprise a respective hook element, preferably a first and a second hook element, longitudinally spaced apart, said hook element being preferably provided, or accessible, from the face of the same second part of said means or block for supporting said signaling means which is facing towards the corresponding signaling panel fixed thereto.

70. The device according to claim 51, wherein the device is movable between an operative signaling position and a rest position, and vice versa, in particular said device being movable, in particular rotating, between an operative position transverse to the vehicle and a rest position longitudinal to the same vehicle, and vice versa.
